(19) United States
(12) Patent Application Publication
(10) Pub. No.: US 2025/0010193 A1
(43) Pub. Date: Jan. 9, 2025

(54) DISCARDING VIRTUAL ITEM

(71) Applicant: Tencent Technology (Shenzhen) Company Limited, Shenzhen (CN)

(72) Inventors: Ziyi Wang, Shenzhen (CN); Cong Tian, Shenzhen (CN); Weijian Cui, Shenzhen (CN); Chenghao Ye, Shenzhen (CN)

(21) Appl. No.: 18/891,394

(22) Filed: Sep. 20, 2024

Related U.S. Application Data
(63) Continuation of application No. PCT/CN2023/124258, filed on Oct. 12, 2023.

(30) Foreign Application Priority Data
Nov. 22, 2022 (CN) 202211466727.X

(51) Int. Cl. A63F 13/55; G06F 3/0484

(52) U.S. Cl. CPC A63F 13/55; G06F 3/0484

(57) ABSTRACT

This application is related to discarding a virtual item in a virtual setting (e.g., a video game). A method comprises: receiving a first operation on an item management control on a user interface when a virtual item owned by a virtual object is not selected. The item management control is configured to trigger management of the virtual item. The method further comprises displaying discard prompt information based on a determination that a virtual item that is unusable by the virtual object; and controlling the virtual object to discard the virtual item owned by the virtual object in response to an end of the first operation.

### CROSS-REFERENCE TO RELATED APPLICATIONS

This application is a continuation application of PCT Application PCT/CN2023/124258, filed Oct. 12, 2023, entitled “Method And Apparatus For Discarding Virtual Prop, Terminal, And Storage Medium” which claims priority to Chinese Patent Application No. 202211466727.X filed on Nov. 22, 2022, entitled “Method, Device, Terminal And Storage Medium For Rapidly Discarding Virtual Prop”, and each of which is incorporated herein by reference in its entirety.

### FIELD OF THE TECHNOLOGY

Aspects of this application relate to the field of man-machine interaction technologies, and in particular, to a method and apparatus for discarding a virtual item, a terminal, and a storage medium.

### BACKGROUND

A first-person shooting game (FPS) is an application program based on a three-dimensional virtual environment. A user can control a virtual object in the virtual environment to perform actions such as walking, running, climbing, and shooting. In addition, a plurality of users can team up online to complete a task through collaboration in a same virtual environment.

In a related art, when a large quantity of useless virtual items exist in virtual items held by the virtual object, the user needs to drag the useless virtual items one by one from an item display window to a discard window, or click the useless virtual items one by one to perform a discard operation, to implement discarding of the useless virtual items.

It can be learnt that, in the related art, in the process of discarding the large quantity of useless virtual items, the same discard operation needs to be continuously repeated. Consequently, the process of discarding the useless virtual items takes a long time.

### SUMMARY

Aspects of this application provide a method and apparatus for discarding a virtual item, a terminal, and a storage medium, to shorten time for discarding a useless virtual item owned by a virtual object and improve efficiency of discarding the useless virtual item. The technical solutions are as follows:

According to an aspect, this application provides a method for discarding a virtual item, where the method is performed by a terminal device (e.g., a computing device), and the method includes:
receiving a first operation on an item management control on a user interface when a virtual item is not selected, the item management control being configured to trigger management of a virtual item owned by a virtual object;
displaying discard prompt information when the virtual item owned by the virtual object includes a useless virtual item, the useless virtual item being a virtual item that is unusable by the virtual object; and
controlling the virtual object to discard the useless virtual item owned by the virtual object when the first operation is ended.

According to another aspect, an aspect of this application provides an apparatus for discarding a virtual item, including:
an operation receiving module, configured to receive a first operation on an item management control when a virtual item is not selected, the item management control being configured to trigger management of a virtual item owned by a virtual object;
a first display module, configured to display discard prompt information when the virtual item owned by the virtual object includes a useless virtual item, the useless virtual item being a virtual item that is unusable by the virtual object; and
a first control module, configured to control the virtual object to discard the useless virtual item owned by the virtual object when the first operation is ended.

According to another aspect, an aspect of this application provides a terminal device, including a processor and a memory. The memory stores at least one instruction. The at least one instruction is loaded and executed by the processor to implement the method for discarding a virtual item described in the foregoing aspect.

According to another aspect, an aspect of this application provides a computer-readable storage medium, having at least one instruction stored therein. The at least one instruction is loaded and executed by a processor to implement the method for discarding a virtual item described in the foregoing aspect.

According to another aspect, an aspect of this application provides a computer program product, including computer instructions. The computer instructions are stored in a computer-readable storage medium. A processor of a terminal device reads the computer instructions from the computer-readable storage medium, and executes the computer instructions, so that the terminal device performs the method for discarding a virtual item provided in the foregoing aspect.

In the aspects of this application, when a virtual item is not selected, if a terminal device receives a first operation on an item management control, the terminal device displays discard prompt information when a virtual item owned by a virtual object includes a useless virtual item. Then, the terminal device controls the virtual object to discard the useless virtual item owned by the virtual object when the first operation is ended. In this way, a user only needs to perform a one-time operation on the item management control to select and discard various useless virtual items at one time, and does not need to select and discard the useless virtual items one by one. This shortens time for discarding the useless virtual item owned by the virtual object, and further improves efficiency of discarding the useless virtual item.

### BRIEF DESCRIPTION OF THE DRAWINGS

FIG. 1 is a schematic diagram of an implementation environment according to an aspect of this application.

FIG. 2 is a flowchart of a method for discarding a virtual item according to an exemplary aspect of this application.

FIG. 3 is a schematic diagram of quickly discarding a useless virtual item according to an exemplary aspect of this application.

FIG. 4 is a flowchart of a method for discarding a virtual item according to another exemplary aspect of this application.

FIG. 5 is a schematic diagram of quickly discarding a useless virtual item in a backpack interface according to an exemplary aspect of this application.

FIG. 6 is a schematic diagram of quickly discarding a useless virtual item in a main interface according to an exemplary aspect of this application.

FIG. 7 is a flowchart of a method for discarding a virtual item according to another exemplary aspect of this application.

FIG. 8 is a schematic diagram of quickly discarding a useless virtual item in a pickup list window according to an exemplary aspect of this application.

FIG. 9 is a schematic diagram of quickly using a virtual supply in a pickup list window according to an exemplary aspect of this application.

FIG. 10 is a flowchart of determining a useless virtual item according to an exemplary aspect of this application.

FIG. 11 is a flowchart of quickly discarding a useless virtual item in a backpack interface according to an exemplary aspect of this application.

FIG. 12 is a flowchart of quickly discarding a useless virtual item in a main interface according to an exemplary aspect of this application.

FIG. 13 is a flowchart of quickly using a virtual supply according to an exemplary aspect of this application.

FIG. 14 is a structural block diagram of an apparatus for discarding a virtual item according to an exemplary aspect of this application.

FIG. 15 is a structural block diagram of a terminal according to an exemplary aspect of this application.

### DETAILED DESCRIPTION

To make objectives, technical solutions, and advantages of this application clearer, implementations of this application are further described below in detail with reference to accompanying drawings.

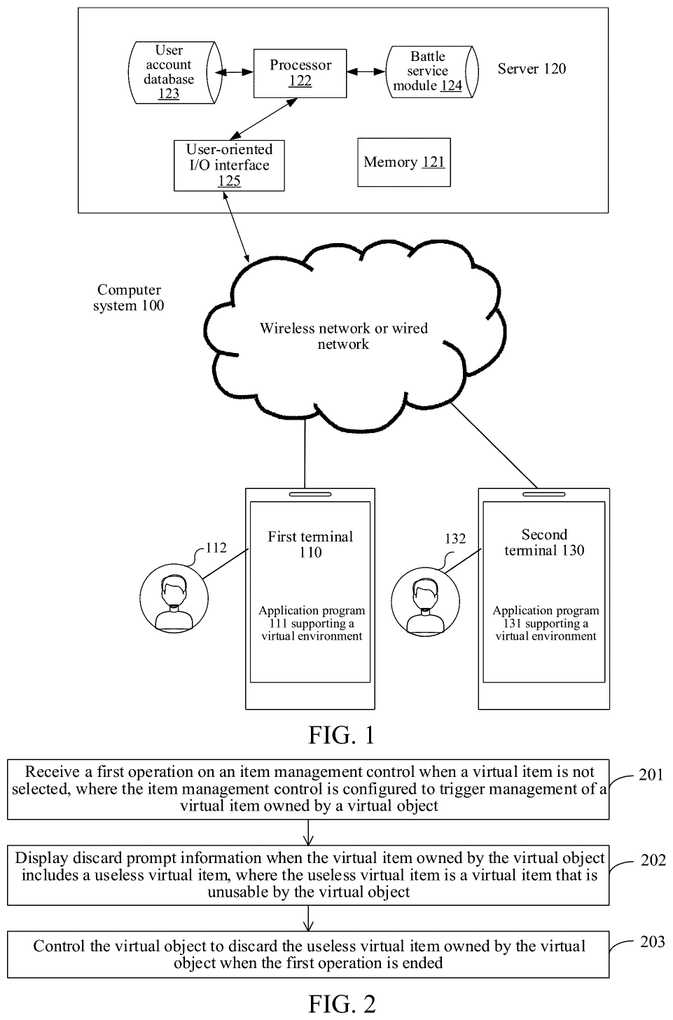

FIG. 1 is a schematic diagram of an implementation environment according to an aspect of this application. The implementation environment may be implemented as a computer system 100. The computer system 100 may include a first terminal 110, a server 120, and a second terminal 130.

A client of an application program 111 supporting a virtual environment is run on the first terminal 110. When the first terminal runs the application program 111, a user interface of the application program 111 is displayed on a screen of the first terminal 110. The application program 111 may be any one of a multiplayer online battle arena (MOBA) game and a simulation game (SLG). In this aspect, an example in which the application program 111 is a first-person shooting game (FPS) is used for description. The first terminal 110 is a terminal used by a first user 112. The first user 112 controls, by using the first terminal 110, a first virtual object located in the virtual environment to perform a movement. The first virtual object may be referred to as a master virtual object of the first user 112. The movement of the first virtual object includes but is not limited to at least one of adjusting body postures, crawling, walking, running, riding, flying, jumping, driving, picking, shooting, attacking, throwing, and skill casting. For example, the first virtual object is a first virtual character such as a simulated person or a cartoon person. The terminal in this application may also be referred to as a terminal device or a computing device.

A client of an application program 131 supporting a virtual environment is run on the second terminal 130. When the second terminal 130 runs the application program 131, a user interface of the application program 131 is displayed on a screen of the second terminal 130. The client may be any one of a MOBA game and an SLG game. In this aspect, an example in which the application program 131 is an FPS game is used for description. The second terminal 130 is a terminal used by a second user 132. The second user 132 controls, by using the second terminal 130, a second virtual object located in the virtual environment to perform a movement, and the second virtual object may be referred to as a master virtual role of the second user 132. For example, the second virtual object is a second virtual character such as a simulated character or a cartoon character.

In some aspects, the first virtual object and the second virtual object are located in a same virtual world. In some aspects, the first virtual object and the second virtual object may belong to a same camp, a same team, or a same organization, have a friend relationship with each other, or have a temporary communication permission. In some aspects, the first virtual object and the second virtual object may belong to different camps, different teams, or different organizations, or have a hostile relationship with each other.

In some aspects, the application programs installed on the first terminal 110 and the second terminal 130 are the same, or the application programs installed on the two terminals are the same type of application programs on different operating system platforms (Android or iOS). In some aspects, the server 120 may be connected to a plurality of terminals. The first terminal 110 may generally refer to one of the plurality of terminals, and the second terminal 130 may generally refer to another one of the plurality of terminals. In this aspect, the first terminal 110 and the second terminal 130 are merely used as an example for description. Device types of the first terminal 110 and the second terminal 130 are the same or different. The device type includes at least one of a smartphone, a tablet computer, an e-book reader, a moving picture experts group audio layer III (MP3) player, a moving picture experts group audio layer VI (MP4) player, a laptop portable computer, an intelligent robot, a vehicle-mounted terminal, and a desktop computer.

FIG. 1 shows only two terminals. However, a plurality of other terminals may access the server 120 in different aspects. In some aspects, one or more terminals are terminals corresponding to a developer. A developing and editing platform for the application program supporting the virtual environment is installed on the terminal. The developer can edit and update the application program on the terminal and transmit an updated application program installation package to the server 120 over a wired network or a wireless network. The first terminal 110 and the second terminal 130 can download the application program installation package from the server 120 to implement update of the application program.

The first terminal 110, the second terminal 130, and the another terminal are connected to the server 120 over the wireless network or the wired network.

The server 120 includes at least one of one server, a server cluster including a plurality of servers, a cloud computing platform, and a virtualization center. The server 120 is configured to provide a backend service for an application program supporting a three-dimensional virtual environment. In some aspects, the server 120 is responsible for primary computing work, and the terminal is responsible for secondary computing work. Alternatively, the server 120 is responsible for secondary computing work, and the terminal is responsible for primary computing work. Alternatively, a distributed computing architecture is adopted between the server 120 and the terminal to perform collaborative computing.

In an example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal, for example, avatars of the user accounts, nicknames of the user accounts, battle effectiveness indexes of the user accounts, and service zones of the user accounts. The battle service module 124 is configured to provide a plurality of battle rooms for the users to battle, for example, a 1V1 battle room, a 3V3 battle room, and a 5V5 battle room. The user-oriented I/O interface 125 is configured to establish communication with the first terminal 110 and/or the second terminal 130 over the wireless network or the wired network for data exchange.

FIG. 2 is a flowchart of a method for discarding a virtual item according to an exemplary aspect of this application. This aspect is described by using an example in which the method is applied to the first terminal 110 or the second terminal 130 in the implementation environment shown in FIG. 1 or the another terminal in the implementation environment, for example, a client running on the first terminal 110, the second terminal 130, or the another terminal. The method includes the following operations (e.g., methods).

Operation 201: Receive a first operation on an item management control when a virtual item is not selected, wherein the item management control is configured to trigger management of a virtual item owned by a virtual object.

In some aspects, the virtual object is a master object of a user in a virtual environment. In other words, the user can control the virtual object, for example, the first virtual object and the second virtual object, to move in the virtual environment. The virtual object may be a virtual role corresponding to an application program. For example, the virtual object may be at least one of a virtual character, a virtual animal, a cartoon character, a virtual vehicle, and a virtual animal.

The virtual environment is a three-dimensional environment in which the virtual object is located in a virtual world in a running process of the application program on the terminal. The virtual environment may be configured for the virtual object to perform a movement. In some examples, the virtual environment is observed by using a camera model.

In some aspects, the camera model automatically follows the virtual role in the virtual world. To be specific, when a position of the virtual object in the virtual world changes, a position of the camera model following the virtual object in the virtual world changes simultaneously, and the camera model may be always within a preset distance range from the virtual object in the virtual world. In some aspects, in the automatic following process, relative positions of the camera model and the virtual object remain unchanged.

The camera model refers to a three-dimensional model located around the virtual object in the virtual world. When a first-person perspective is adopted, the camera model is located near or on the head of the virtual object. When a third-person perspective is adopted, the camera model may be located behind and bound to the virtual object, or may be located at any location at a preset distance from the virtual object. The virtual object in the virtual world may be observed from different angles by using the camera model. In some aspects, when the third-person perspective is a first-person over-the-shoulder perspective, the camera model is located behind the virtual object (for example, behind the head and shoulders of the virtual object). In some aspects, in addition to the first-person perspective and the third-person perspective, other perspectives, for example, a top-down perspective, are further included. When the top-down perspective is adopted, the camera model may be located above the head of the virtual object. The top-down perspective is a perspective from which the virtual world is observed from the air. In some aspects, the camera model is not actually displayed in the virtual world. In other words, the camera model is not displayed in the virtual world displayed in a user interface.

In some aspects, the item management control is configured to trigger the management of the virtual item owned by the virtual object. The virtual object may own the virtual item by picking up the virtual item in the virtual environment, by receiving a gift from another virtual object in a same camp, or by receiving a grant from a system when completing a system task. This is not limited in this aspect of this application.

The virtual item is an item provided by the application program for the virtual object to use. The virtual item may be a simulated item, a fictional item, or a semi-simulated semi-fictional item. For example, the virtual item may include virtual ammunition, a virtual accessory, a virtual chip, a virtual drug, and the like. This is not limited in this aspect of this application.

In a possible implementation, because a quantity of virtual items that can be owned and stored by the virtual object in the virtual environment is limited, the virtual object needs to manage the virtual item owned by the virtual object, for example, use the virtual item, give the virtual item away, and discard the virtual item. Different from a related art in which a corresponding virtual item needs to be selected before the management of the virtual item can be implemented, in this aspect of this application, when the virtual item is not selected, the terminal may receive the first operation on the item management control to implement the management of the virtual item.

In some aspects, the first operation may be a touch-and-hold operation, a gesture operation, a voice control operation, and the like. This is not limited in this aspect of this application. For example, when the terminal device includes a touch screen, the user may perform the first operation on the item management control in the user interface by using the touch screen.

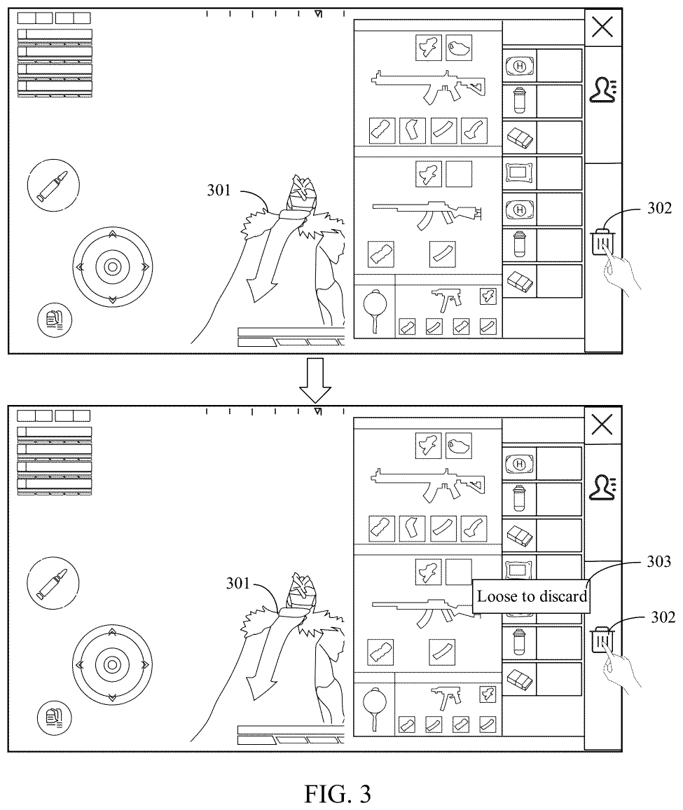

For example, as shown in FIG. 3, when the user does not select any virtual item, the terminal receives, in response to a first operation performed by the user on an item management control 302, the first operation of the user on the item management control 302. Triggered by the first operation, the item management control 302 may be configured to manage a virtual item owned by a virtual object 301.

A case in which the virtual item is selected may indicate that the user switches the virtual item to a selected state by performing an operation. For example, the user may select the virtual item by performing a click operation. A case in which the virtual item is not selected may indicate that the user does not perform a click operation on any virtual item to select the virtual item.

Operation 202: Display discard prompt information when the virtual item owned by the virtual object includes a useless virtual item, where the useless virtual item is a virtual item that is unusable by the virtual object.

In some aspects, after receiving the first operation, the terminal checks the virtual item owned by the virtual object to determine whether the virtual object includes a useless virtual item. When the virtual object includes a useless virtual item, the terminal displays the discard prompt information.

In this aspect, the useless virtual item may be a virtual item that cannot be directly used by the virtual object, for example, virtual ammunition and a virtual drug. The useless virtual item may also be a virtual item that is unusable by the virtual object by using another virtual item, for example, a virtual item that is unusable by a virtual weapon owned by the virtual object (for example, a virtual accessory that does not match the virtual weapon owned by the virtual object). This is not limited in this aspect of this application. The “useless” may indicate being of no use or need.

The discard prompt information is configured for indicating whether the virtual item owned by the virtual object includes a useless virtual item. When there is a useless virtual item, the discard prompt information is configured for indicating that there is a useless virtual item that can be discarded. When there is no useless virtual item, the discard prompt information is configured for indicating that there is no useless virtual item that can be discarded.

In a possible implementation, the item management control may be configured to implement discarding of the useless virtual item. For example, the useless virtual item may be the virtual item that is unusable by the virtual weapon owned by the virtual object, for example, the virtual ammunition and the virtual accessory. The useless virtual item may also be the virtual item that is unusable by the virtual object, for example, a virtual supply. The user triggers, by using the item management control, the terminal to determine and discard these useless virtual items.

In a possible implementation, the terminal may first determine an item type of the virtual item. When the virtual item is the virtual ammunition or the virtual accessory, the terminal further determines whether the virtual ammunition or the virtual accessory is a useless virtual item. If the virtual ammunition or the virtual accessory is unusable by any virtual item owned by the virtual object, the terminal determines that the virtual ammunition or the virtual accessory is a useless virtual item and can be discarded. When the virtual item is not the virtual ammunition or the virtual accessory, the terminal does not determine the virtual item. In other words, the terminal considers by default the virtual item as a useful virtual item. The useful virtual item may be a virtual item used by the virtual role.

In a possible implementation, when the virtual item is a useless virtual item, the terminal may display a useless identifier in a display box corresponding to the useless virtual item, to prompt the user that the virtual item is a useless virtual item. In some aspects, when identifying the useless virtual item, the terminal may switch the useless virtual item to the selected state. The user may switch the useless virtual item in the selected state to an unselected state, to cancel discarding of the useless virtual item. In this way, flexibility of discarding the useless virtual item can be improved.

In a possible implementation, when the received first operation on the item management control satisfies a first condition, and the virtual item owned by the virtual object includes the useless virtual item, the terminal displays the discard prompt information, to prompt the user that the terminal is to control the virtual object to discard the useless virtual item.

In some aspects, the first condition may be set based on an operation parameter of the first operation. For example, the first condition may be that duration of the first operation reaches a corresponding duration threshold or that an operation force of the first operation reaches a corresponding force threshold. This is not limited in this aspect of this application.

For example, as shown in FIG. 3, when the first operation satisfies the first condition, and the virtual item owned by the virtual object 301 includes the useless virtual item, discard prompt information 303 is displayed.

Operation 203: Control the virtual object to discard the useless virtual item owned by the virtual object when the first operation is ended (e.g., in response to an end of the first operation).

The end of the first operation may indicate that the user stops to perform an operation on the item management control. For example, when the first operation is a touch-and-hold operation, in response to the user stopping to touch and hold the item management control, the terminal may determine that the first operation is ended.

In a possible implementation, the terminal may control the virtual object to discard the useless virtual item owned by the virtual object when the first operation is ended, to directly discard the useless virtual item when the virtual item is not selected. In other words, the terminal can simultaneously trigger, through the first operation, determining, selection and discarding of the useless virtual item. There is no need to manually determine, select and discard the useless virtual items one by one. In this way, efficiency of discarding the useless virtual item is effectively improved.

In some examples, the useless virtual items discarded by the virtual object may be all useless virtual items owned by the virtual object, or may be a part of useless virtual items owned by the virtual object, for example, a useless virtual item that has not been used by the virtual object for some time. This is not limited in this example of this application.

For example, as shown in FIG. 3, the terminal controls the virtual object 301 to discard all useless virtual items owned by the virtual object 301 when the first operation is ended.

In conclusion, in this example of this application, when a virtual item is not selected, if a terminal device receives a first operation on an item management control, the terminal device displays discard prompt information when a virtual item owned by a virtual object includes a useless virtual item. Then, the terminal device controls the virtual object to discard the useless virtual item owned by the virtual object when the first operation is ended. In this way, a user only needs to perform a one-time operation on the item management control to select and discard various useless virtual items at one time, and does not need to select and discard the useless virtual items one by one. This shortens time for discarding the useless virtual item owned by the virtual object, and further improves efficiency of discarding the useless virtual item.

In a possible implementation, to quickly discard the useless virtual item owned by the virtual object in different interfaces, the terminal may set a corresponding item management control in a corresponding interface, or reuse another control in an interface as an item management control.

In a possible implementation, the terminal may set the item management control as a discard control in a backpack interface, or reuse a backpack control as an item management control in a main interface.

FIG. 4 is a flowchart of a method for discarding a virtual item according to another exemplary aspect of this application. This aspect is described by using an example in which the method is applied to the first terminal 110 or the second terminal 130 in the implementation environment shown in FIG. 1 or the another terminal in the implementation environment, for example, a client running on the first terminal 110, the second terminal 130, or the another terminal. The method includes the following operations.

Operation 401: Receive a first operation on a discard control in a backpack interface when a virtual item in the backpack interface is not selected.

The backpack interface may be a user interface opened through a backpack control in a main interface, and may be configured to display a virtual item currently owned by a virtual object. The main interface may be a user interface configured to display a virtual environment picture, where the virtual environment picture may be a picture obtained through the foregoing camera model by observing a virtual environment by a virtual role. In some aspects, after the virtual object obtains a virtual backpack item, the terminal activates the backpack control, so that the virtual object can use the virtual backpack item. A corresponding user interface of the virtual backpack item is the backpack interface. In some aspects, the virtual backpack item corresponds to a certain backpack capacity, namely, a maximum quantity of virtual items that can be stored. The backpack capacity of the virtual backpack item is positively correlated with a level of the virtual backpack. Each virtual item has a certain item weight, and may occupy a certain backpack capacity. The item weight and the backpack capacity are in one-to-one correspondence.

In a possible implementation, when the backpack interface is displayed, the terminal may determine the discard control in the backpack interface as an item management control. All virtual items owned by the virtual object are displayed in the backpack interface, so that the terminal can receive the first operation of a user on the discard control in the backpack interface when the virtual item in the backpack interface is not selected. A case in which the virtual item in the backpack interface is not selected may indicate that the user does not select any virtual item displayed in the backpack interface. The discard control may be configured to trigger selection and discarding of a useless virtual item.

In some aspects, the first operation may be a touch-and-hold operation on the discard control, a gesture operation on the discard control, and the like. This is not limited in this aspect of this application.

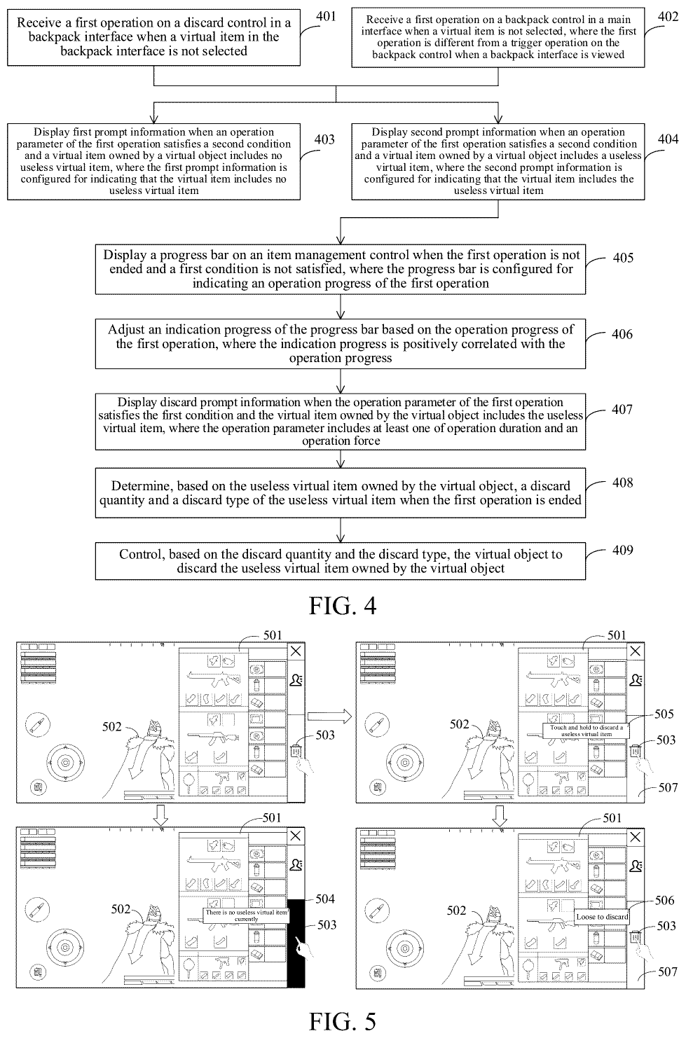

For example, as shown in FIG. 5, the terminal displays a backpack interface 501. When a virtual item in the backpack interface 501 is not selected by the user, in response to a touch-and-hold operation of the user on a discard control 503, the terminal receives the touch-and-hold operation of the user on the discard control 503 in the backpack interface 501.

Operation 402: Receive a first operation on the backpack control in the main interface when the virtual item is not selected, where the first operation is different from a trigger operation on the backpack control when the backpack interface is viewed.

In a possible implementation, when the main interface is displayed, the terminal may reuse the backpack control in the main interface as an item management control. The virtual environment and the virtual object are displayed in the main interface, so that the terminal receives the first operation of the user on the backpack control in the main interface when the virtual item is not selected. In other words, the backpack control may not only be configured to open the backpack interface, but also be used as the item management control to manage the virtual items owned by the virtual role.

In some aspects, the first operation is different from the trigger operation of the user on the backpack control when the backpack interface is viewed. For example, when receiving a click operation on the backpack control, the terminal may open the backpack interface, so that the user can view the backpack interface. In this way, the first operation may be set to another operation manner other than the click operation, for example, a double-click operation, a touch-and-hold operation, and a gesture operation. This is not limited in this aspect of this application.

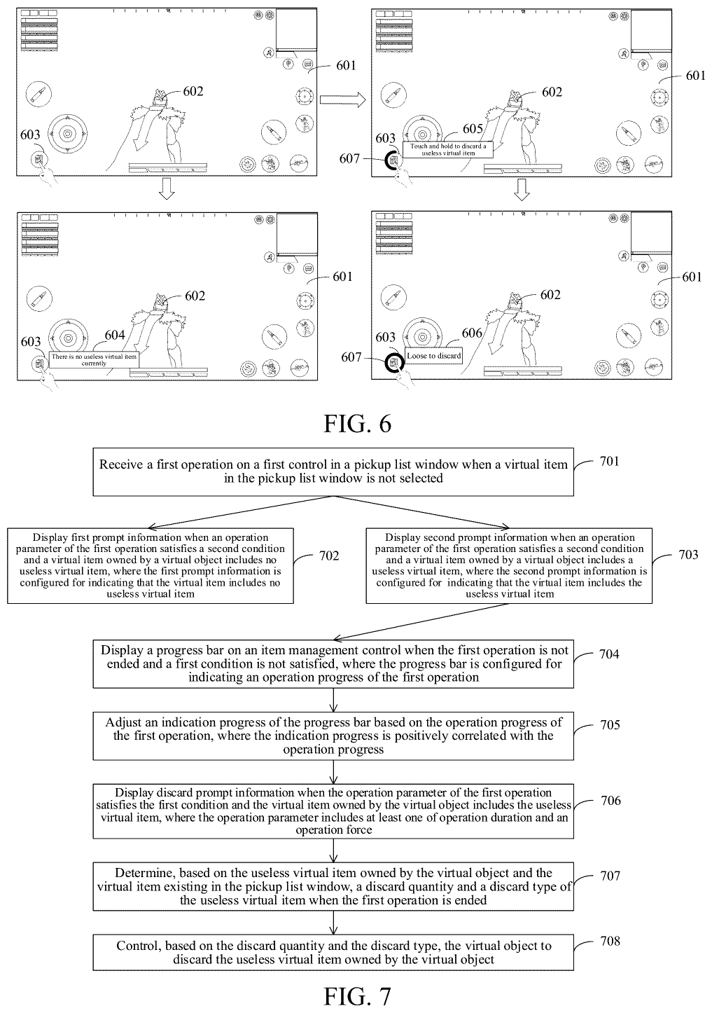

For example, as shown in FIG. 6, the terminal displays a main interface 601. When a virtual item is not selected by the user, in response to a touch-and-hold operation of the user on a backpack control 603, the terminal receives the touch-and-hold operation of the user on the backpack control 603 in the main interface 601.

In some aspects, operation 401 and operation 402 may be two parallel operations. Operation 401 and operation 402 may exist independently or in combination. In other words, the terminal may obtain the first operation no matter operation 401 or operation 402 is performed.

Operation 403: Display first prompt information when the operation parameter of the first operation satisfies a second condition and the virtual item owned by the virtual object includes no useless virtual item, where the first prompt information is configured for indicating that the virtual item includes no useless virtual item.

In a possible implementation, the first operation on the item management control is directly received when the virtual item is not selected. The useless virtual item may not exist in the virtual item owned by the virtual object. In other words, there is no need to discard the useless virtual item through the first operation. Therefore, to prompt the user in time that the useless virtual item does not exist in the virtual item owned by the virtual object, when the operation parameter of the first operation satisfies the second condition but does not satisfy a first condition, and the useless virtual item does not exist in the virtual item owned by the virtual object, the terminal displays the first prompt information. The first prompt information is configured for indicating the user that the virtual item does not include the useless virtual item.

In this aspect, the operation parameter may include at least one of operation duration and an operation force. The second condition may also be set based on the operation parameter. In some aspects, the second condition may be that duration of the first operation reaches a corresponding duration threshold, where the duration threshold is less than a duration threshold corresponding to the first condition. Alternatively, the second condition may be that an operation force of the first operation reaches a corresponding force threshold, where the force threshold is less than a force threshold corresponding to the first condition. This is not limited in this aspect of this application.

For example, as shown in FIG. 5, when the touch-and-hold operation of the user on the discard control 503 reaches 2 seconds, and the virtual item owned by virtual object 502 does not include the useless virtual item, the terminal displays first prompt information 504 to prompt the user that there is no useless virtual item currently.

For example, as shown in FIG. 6, when the touch-and-hold operation of the user on the backpack control 603 reaches 2 seconds, and the virtual item owned by virtual object 602 does not include the useless virtual item, the terminal displays first prompt information 604 to prompt the user that there is no useless virtual item currently.

Operation 404: Display second prompt information when the operation parameter of the first operation satisfies a second condition and the virtual item owned by the virtual object includes the useless virtual item, where the second prompt information is configured for indicating that the virtual item includes the useless virtual item.

In a possible implementation, when the virtual item owned by the virtual object includes the useless virtual item, after receiving the first operation on the item management control, to prompt the user in time that the virtual item currently owned by the virtual object includes the useless virtual item and the useless virtual item can be discarded through the first operation, the terminal may display the second prompt information when the first operation satisfies the second condition but does not satisfy a first condition. The second prompt information is configured for indicating the user that the virtual item includes the useless virtual item and continuing to trigger the first operation can implement discarding of the useless virtual item.

For example, as shown in FIG. 5, when the touch-and-hold operation of the user on the discard control 503 reaches 2 seconds, and the virtual item owned by virtual object 502 includes the useless virtual item, the terminal displays second prompt information 505 to prompt the user that there is a useless virtual item currently.

For example, as shown in FIG. 6, when the touch-and-hold operation of the user on the backpack control 603 reaches 2 seconds, and the virtual item owned by virtual object 602 includes the useless virtual item, the terminal displays second prompt information 605 to prompt the user that there is a useless virtual item currently.

In some aspects, operation 403 and operation 404 may be two parallel operations. In other words, only one of operation 403 and operation 404 can be triggered at the same time.

Operation 405: Display a progress bar on the item management control when the first operation is not ended and the first condition is not satisfied, where the progress bar is configured for indicating an operation progress of the first operation.

In a possible implementation, after displaying the second prompt information, to more specifically notify the user of the operation progress of the first operation, the terminal may display the progress bar on the item management control when the first operation is not ended and the first condition is not satisfied, to indicate the operation progress of the first operation through the progress bar.

In some aspects, an expression form of the progress bar may be determined based on a shape of the item management control. For example, if the item management control is in a shape of a circle, the expression form of the progress bar may be a circle around the item management control. If the item management control is in a shape of a column, the expression form of the progress bar may be a column that fills the item management control. This is not limited in this aspect of this application.

For example, as shown in FIG. 5, after displaying the second prompt information, the terminal displays a progress bar 507 on the discard control 503 when the touch-and-hold operation of the user on the discard control 503 is not ended and the touch-and-hold operation does not reach, for example, 5 seconds (namely, the first condition), to notify the user of the operation progress of the first operation.

For example, as shown in FIG. 6, after displaying the second prompt information, the terminal displays a progress bar 607 on the backpack control 603 when the touch-and-hold operation of the user on the backpack control 603 is not ended and the touch-and-hold operation does not reach 5 seconds, to notify the user of the operation progress of the first operation.

Operation 406: Adjust an indication progress of the progress bar based on the operation progress of the first operation, where the indication progress is positively correlated with the operation progress.

In a possible implementation, the terminal prompts the operation progress of the first operation to the user through the indication progress of the progress bar. In other words, the terminal adjusts the indication progress of the progress bar based on the operation progress of the first operation, where the indication progress is positively correlated with the operation progress.

In some aspects, the operation progress may be represented as the operation duration. In other words, the indication progress is positively correlated with the operation duration of the first operation. The operation progress may alternatively be represented as the operation force. In other words, the indication progress is positively correlated with the operation force of the first operation.

For example, as shown in FIG. 5, an indication progress of the progress bar 507 is positively correlated with touch-and-hold duration of the touch-and-hold operation of the user on the discard control 503.

For example, as shown in FIG. 6, an indication progress of the progress bar 607 is positively correlated with touch-and-hold duration of the touch-and-hold operation of the user on the backpack control 603.

Operation 407: Display the discard prompt information when the operation parameter of the first operation satisfies the first condition and the virtual item owned by the virtual object includes the useless virtual item, where the operation parameter includes at least one of the operation duration and the operation force.

In some aspects, the operation parameter of the first operation may include at least one of the operation duration and the operation force. For example, when the first operation is a touch-and-hold operation, the operation parameter of the first operation may be represented as duration of the touch-and-hold operation, or may be represented as an operation force of the touch-and-hold operation. Correspondingly, the first condition may be first duration, or may be a first force. The first duration or the first force may be set and adjusted according to a use requirement. This is not limited in this aspect of this application. The useless virtual item is discarded only when the operation parameter of the first operation satisfies the first condition, so that the user performs the first operation according to a need of the user. This effectively avoids probability that the user unintentionally triggers the first operation, so that rationality of discarding the useless virtual item is improved.

In a possible implementation, when the operation duration of the first operation reaches the first duration and the virtual item owned by the virtual object includes the useless virtual item, the terminal displays the discard prompt information, to prompt the user that the virtual object is to be controlled to discard the useless virtual item.

In a possible implementation, when the operation force of the first operation reaches the first force and the virtual item owned by the virtual object includes the useless virtual item, the terminal displays the discard prompt information, to prompt the user that the virtual object is to be controlled to discard the useless virtual item.

For example, as shown in FIG. 5, when the touch-and-hold operation of the user on the discard control 503 reaches 5 seconds, and the virtual item owned by the virtual object 502 includes the useless virtual item, the terminal displays the discard prompt information 506, to prompt the user that the virtual object is to be controlled to discard the useless virtual item.

For example, as shown in FIG. 6, when the touch-and-hold operation of the user on the backpack control 603 reaches, for example, 5 seconds, and the virtual item owned by the virtual object 602 includes the useless virtual item, the terminal displays the discard prompt information 606, to prompt the user that the virtual object is to be controlled to discard the useless virtual item.

Operation 408: Determine, based on the useless virtual item owned by the virtual object, a discard quantity and a discard type of the useless virtual item when the first operation is ended.

The discard quantity refers to a quantity of useless virtual items to be discarded, and the discard type refers to a type of the useless virtual item to be discarded.

In a possible implementation, the virtual item owned by the virtual object is obtained based on a related operation of the virtual object in the virtual environment. The useless virtual item currently owned by the virtual item may be needed later in a process of performing an operation by the virtual object, or the useless virtual item may be needed by another virtual object belonging to the same camp as the virtual object. Therefore, when the first operation is ended, the terminal may first determine, based on the useless virtual item currently owned by the virtual object, the discard quantity and the discard type of the useless virtual item, to avoid that the useless virtual item is needed again after the useless virtual item is discarded.

In a possible implementation, when the first operation is ended, the terminal may sort the useless virtual item based on an item attribute of the useless virtual item and historical item usage of the virtual object, to obtain a first sorting result. In this way, the terminal determines the discard quantity and the discard type of the useless virtual item based on the first sorting result.

In some aspects, the item attribute may include at least one of an item quantity and an item value.

In a possible implementation, to avoid that the useless virtual item is needed again after the useless virtual item is discarded, the terminal may set a quantity lower limit for each useless virtual item. In other words, the terminal only discards useless virtual items whose quantity is a partial quantity that exceeds the quantity lower limit, but does not discard all the useless virtual items. In some aspects, the user may preset the quantity lower limit before a game. Alternatively, after the first operation is ended, the user may directly set the quantity lower limit based on a current game situation by displaying a quantity setting control. Then, after the first operation is ended, the terminal determines the discard quantity and the discard type of the useless virtual item based on the quantity lower limit, and reserves a certain quantity of useless virtual items.

In a possible implementation, because different virtual items have different item values in the virtual environment, the terminal may not discard the useless virtual item when the virtual item is unusable by a virtual weapon currently owned by the virtual object or is unusable by the virtual object, but an item value of the virtual item is greater than a threshold.

In a possible implementation, the terminal may not discard the useless virtual item when the virtual item is unusable by a virtual weapon currently owned by the virtual object or is unusable by the virtual object, but based on the historical item usage of the virtual object, the virtual item is a virtual item used frequently by the virtual object.

In a possible implementation, the terminal may comprehensively sort the useless virtual items based on a current remaining quantity of each useless virtual item, an item value of each useless virtual item, and historical item use frequency of each useless virtual item. The terminal determines a useless virtual item whose sorting priority is lower than a threshold as the useless virtual item to be discarded. Alternatively, for various useless virtual items whose sorting priorities are lower than a threshold, the terminal reserves a certain quantity of the useless virtual items, and determines an excess part as useless virtual items to be discarded.

For example, the terminal may first sort the useless virtual item based on the item attribute to obtain a preliminary sorting result (including removing some useless virtual items that do not need to be discarded), and then adjust the preliminary sorting result based on the historical item usage (for example, move a sorting position of a used useless virtual item forward) to obtain the first sorting result. For example, a client may determine the sorting priority of each useless virtual item based on the item attribute and the historical item usage, and then sort the useless virtual items according to orders of the sorting priorities from the largest to the smallest, to obtain the first sorting result.

In some aspects, a type of a useless virtual item whose sorting priority is lower than the threshold in the first sorting result is determined as the discard type, and a quantity of useless virtual items whose sorting priority is lower than the threshold in the first sorting result is determined as the discard quantity.

Operation 409: Control, based on the discard quantity and the discard type, the virtual object to discard the useless virtual item owned by the virtual object.

Further, after determining the discard quantity and the discard type of the useless virtual item, the terminal controls the virtual object to discard useless virtual items of the corresponding discard quantity and discard type.

In the foregoing aspect, the terminal implements discarding of the useless virtual items in different interfaces by respectively setting the item management controls in the backpack interface and the main interface. The terminal sets the progress bar on the item management control to display the operation progress of the first operation to the user in time, so that a display effect of the item management control is increased.

In addition, the discard quantity and the discard type of the useless virtual item are determined based on the item attribute of the useless virtual item currently owned by the virtual object and the historical item usage of the virtual object. This avoids that the useless virtual item is needed but is not available after the useless virtual item is discarded, implements appropriate discarding of the useless virtual item, and improves efficiency of discarding the useless virtual item.

In a possible implementation, in an item picking process of the virtual object, the terminal displays an item list window. To avoid that the useless virtual item owned by the virtual object occupies an item capacity and the virtual object cannot pick up a current virtual item, the terminal may also set an item management control in the item list window.

FIG. 7 is a flowchart of a method for discarding a virtual item according to another exemplary aspect of this application. This aspect is described by using an example in which the method is applied to the first terminal 110 or the second terminal 130 in the implementation environment shown in FIG. 1 or the another terminal in the implementation environment, for example, a client running on the first terminal 110, the second terminal 130, or the another terminal. The method includes the following operations.

Operation 701: Receive a first operation on a first control in a pickup list window when the virtual item in the pickup list window is not selected.

The pickup list window may be configured to display a virtual item that is found and that can be picked up by a virtual object. For example, when the virtual object is close to an item to be picked up on the virtual ground, a terminal automatically displays the pickup list window, and the item to be picked up is displayed in the pickup list window. For another example, in response to an opening operation of a user on an item pack (or an item box), the terminal displays the pickup list window, and at least one to-be-picked-up item in the item pack is displayed in the pickup list window.

In a possible implementation, the terminal may set the first control in the pickup list window as an item management control, where the first control may be a newly set discard control, or may be a reused backpack control in the pickup list window that is configured to open the backpack interface. This is not limited in this aspect of this application.

In a possible implementation, after the pickup list window is displayed, the terminal receives the first operation of the user on the first control in the pickup list window when the virtual item in the pickup list window is not selected.

In some aspects, the first operation may be a touch-and-hold operation on the first control, a gesture operation on the first control, and the like. This is not limited in this aspect of this application.

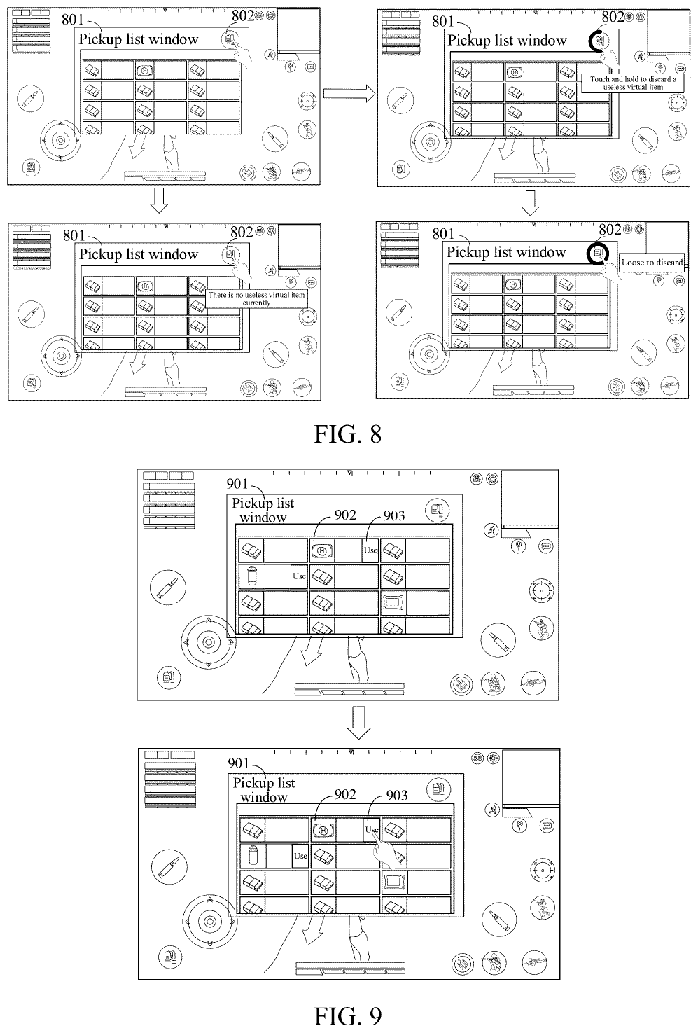

For example, as shown in FIG. 8, the terminal displays a pickup list window 801. When a virtual item in the pickup list window 801 is not selected by the user, in response to a touch-and-hold operation of the user on a backpack control 802, the terminal receives the touch-and-hold operation of the user on the backpack control 802 in the pickup list window 801.

Operation 702: Display first prompt information when the operation parameter of the first operation satisfies a second condition and the virtual item owned by the virtual object includes no useless virtual item, where the first prompt information is configured for indicating that the virtual item includes no useless virtual item.

Operation 703: Display second prompt information when the operation parameter of the first operation satisfies a second condition and the virtual item owned by the virtual object includes the useless virtual item, where the second prompt information is configured for indicating that the virtual item includes the useless virtual item.

Operation 704: Display a progress bar on the item management control when the first operation is not ended and the first condition is not satisfied, where the progress bar is configured for indicating an operation progress of the first operation.

Operation 705: Adjust an indication progress of the progress bar based on the operation progress of the first operation, where the indication progress is positively correlated with the operation progress.

Operation 706: Display the discard prompt information when an operation parameter of the first operation satisfies a first condition and the virtual item owned by the virtual object includes the useless virtual item, where the operation parameter includes at least one of operation duration and an operation force.

For specific implementations of operations 702 to 706, refer to operations 403 to 407. Details are not described in this aspect.

Operation 707: Determine, based on the useless virtual item owned by the virtual object and the virtual item existing in the pickup list window, a discard quantity and a discard type of the useless virtual item when the first operation is ended.

In a possible implementation, the virtual item owned by the virtual object is obtained based on a related operation of the virtual object in the virtual environment. The useless virtual item currently owned by the virtual item may be needed later in a process of performing an operation by the virtual object, or the useless virtual item may be needed by another virtual object belonging to the same camp as the virtual object. In addition, a virtual item that is needed by the virtual object or that is used frequently by the virtual object may exist in the pickup list window. The virtual object needs to pick up the virtual item after discarding the useless virtual item owned by the virtual object. Therefore, when the first operation is ended, the terminal may first determine, based on the useless virtual item currently owned by the virtual object and the virtual item in the pickup list window, the discard quantity and the discard type of the useless virtual item, to avoid that the useless virtual item is needed again after the useless virtual item is discarded and ensure that a useful virtual item in the pickup list window can be picked up.

In a possible implementation, when the first operation ends, the terminal may sort the useless virtual item based on an item attribute of the useless virtual item owned by the virtual object, an item attribute of the virtual item existing in the pickup list window, and historical item usage of the virtual object, to obtain a second sorting result. In this way, the terminal determines the discard quantity and the discard type of the useless virtual item based on the second sorting result.

In some aspects, the item attribute includes at least one of an item quantity and an item value.

In a possible implementation, to avoid that the useless virtual item is needed again after the useless virtual item is discarded, the terminal may set a quantity lower limit for each useless virtual item. In other words, the terminal only discards useless virtual items whose quantity is a partial quantity that exceeds the quantity lower limit, but does not discard all the useless virtual items. In other words, the partial quantity that exceeds the quantity lower limit is determined as the discard quantity. In some aspects, the user may preset the quantity lower limit before a game. Alternatively, after the first operation is ended, the user may directly set the quantity lower limit based on a current game situation by displaying a quantity setting control. Then, after the first operation is ended, the terminal determines the discard quantity and the discard type of the useless virtual item based on the quantity lower limit, and reserves a certain quantity of useless virtual items.

In a possible implementation, because different virtual items have different item values in the virtual environment, the terminal may not discard the useless virtual item when the virtual item is unusable by a virtual weapon currently owned by the virtual object or is unusable by the virtual object, but an item value of the virtual item is greater than a threshold. In other words, a quantity and a type of another useless virtual item other than the useless virtual item that does not need to be discarded are determined as the discard quantity and the discard type.

In a possible implementation, the terminal may not discard the useless virtual item when the virtual item is unusable by a virtual weapon currently owned by the virtual object or is unusable by the virtual object, but based on the historical item usage of the virtual object, the virtual item is a virtual item used frequently by the virtual object. In other words, a quantity and a type of another useless virtual item other than the useless virtual item that does not need to be discarded are determined as the discard quantity and the discard type.

In a possible implementation, when a useful virtual item needed by the virtual object or a virtual item used frequently by the virtual object exists in the pickup list window, to enable the virtual object to pick up as many virtual items as possible after discarding the useless virtual item, the terminal may determine, based on the currently owned useless virtual item and a useful virtual item to be picked up in the pickup list window, the discard quantity and the discard type of the useless virtual item. For example, the terminal may first determine an item capacity corresponding to the useful virtual item to be picked up in the pickup list window, and then discard, based on the item capacity, a useless virtual item with the corresponding item capacity.

For example, the terminal may first sort the useless virtual item based on the item attribute of the useless virtual item in the backpack to obtain a preliminary sorting result, and then adjust the preliminary sorting result based on the historical item usage (for example, move a sorting position of a used useless virtual item forward) to obtain a transitional sorting result. The transitional sorting result does not include the useless virtual item that does not need to be discarded and that is determined based on the item attribute and the historical item usage. Finally, the terminal determines, based on the useful virtual item to be picked up in the pickup list window, whether the transitional sorting result satisfies a condition for picking up the useful virtual item. If the transitional sorting result satisfies the condition for picking up the useful virtual item, the transitional sorting result is determined as the second sorting result. A corresponding quantity and type of each useless virtual item in the second sorting result are the discard quantity and the discard type.

Operation 708: Control, based on the discard quantity and the discard type, the virtual object to discard the useless virtual item owned by the virtual object.

For a specific implementation of this operation, refer to operation 409. Details are not described in this aspect.

In the foregoing aspect, the item management control is set in the pickup list window, so that the user can first discard the useless virtual item owned by the virtual object before controlling the virtual object to pick up a virtual item. In this way, a rate of picking up, by the virtual object, the useful virtual item in the current pickup list window is improved.

In addition, the discard quantity and the discard type of the useless virtual item are determined based on the item attribute of the useless virtual item owned by the virtual object, the item attribute of the virtual item existing in the pickup list window, and the historical item usage of the virtual object. This implements appropriate discarding of the useless virtual item, and improves efficiency of discarding the useless virtual item.

In a possible implementation, when a virtual supply exists in the displayed pickup list window, to control the virtual object to directly use the corresponding virtual supply without picking up the virtual supply into the backpack first, the terminal may set a use control in a display box corresponding to the virtual supply in the pickup list window, to directly control the virtual object to use the virtual supply. This process may include the following operations.

1. Display a use control in a display box corresponding to the virtual supply when a virtual supply exists in the pickup list window, where the use control is configured to implement direct use of the virtual supply.

The virtual supply is used to supply the virtual object. For example, the virtual supply may be used to recover a health value, a physical strength value, and the like of the virtual object. A shape and a size of the use control is not limited in this aspect of this application, and the use control may be set and adjusted according to a use requirement.

In a possible implementation, when a virtual supply exists in the pickup list window, the terminal may display a use control in a display box corresponding to the virtual supply, to implement direct use of the virtual supply through the use control.

In a possible implementation, because different virtual supplies have different supply functions, to improve efficiency of determining which virtual supply is to be used by the virtual object, the terminal may determine, based on a supply type to which the virtual supply belongs and a current object attribute of the virtual object, a target virtual supply applicable to virtual object in the pickup list window, and display a use control in a display box corresponding to the target virtual supply, to prompt the user to use the target virtual supply. For example, when a virtual supply exists in the pickup list window, the terminal first determines a supply type to which the virtual supply belongs, then determines, based on the supply type and the object attribute of the virtual object, a target virtual supply applicable to the virtual object, and finally displays a use control in a display box corresponding to the target virtual supply for direct use by the virtual object.

In some aspects, the object attribute of the virtual object may be a health value, an energy value, and the like of the virtual object. This is not limited in this aspect of this application.

For example, the supply type of the virtual supply may include an energy drink, a medical kit, a medical pack, a bandage, a painkiller, epinephrine, and the like.

In an example, when a current energy value of the virtual object is less than 100 and an energy drink exists in the pickup list window, the terminal may display a use control in a display box corresponding to the energy drink.

For example, as shown in FIG. 9, when a virtual supply 902 exists in a pickup list window 901, if it is detected that the virtual object needs to use the virtual supply 902, a use control 903 is displayed in a display box corresponding to the virtual supply 902 for direct use by the virtual object.

2. Control the virtual object to use the virtual supply in response to a second operation on the use control.

In a possible implementation, the terminal controls the virtual object to use the virtual supply when receiving the second operation of the user on the use control.

In some aspects, the second operation is used to trigger the use control. For example, the second operation may be a click operation, a double-click operation, a touch-and-hold operation, and the like on the use control. This is not limited in this aspect of this application.

For example, as shown in FIG. 9, the terminal controls the virtual object to use the virtual supply 902 in response to a click operation of the user on the use control 903.

In the foregoing aspect, the use control is displayed in the display box of the virtual supply in the pickup list window, so that the virtual object can be directly controlled to quickly use the virtual supply without adding the virtual supply to the backpack. In this way, efficiency of using the virtual supply is improved.

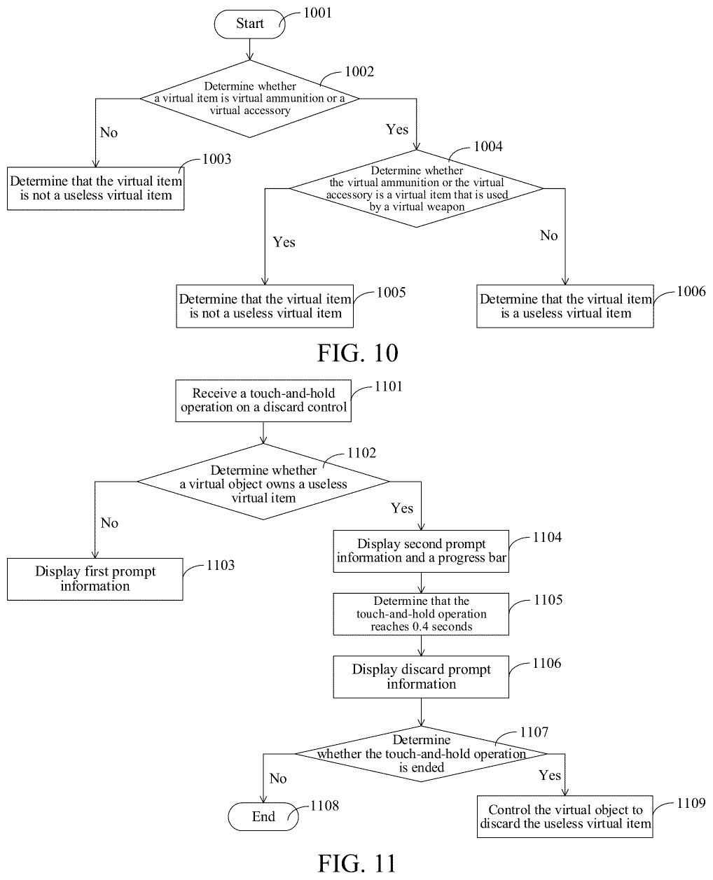

FIG. 10 is a flowchart of determining a useless virtual item according to an exemplary aspect of this application.

Operation 1001: Start.

Operation 1002: Determine whether a virtual item is virtual ammunition or a virtual accessory.

A terminal performs determining on a virtual item currently owned by a virtual object and determines whether the virtual item is virtual ammunition or a virtual accessory. When the virtual item is not the virtual ammunition or the virtual accessory, operation 1003 is performed. When the virtual item is the virtual ammunition or the virtual accessory, operation 1004 is performed.

Operation 1003: Determine that the virtual item is not a useless virtual item.

When the virtual item is not the virtual ammunition or the virtual accessory, the terminal determines that the virtual item is not the useless virtual item.

Operation 1004: Determine whether the virtual ammunition or the virtual accessory is a virtual item that is used by a virtual weapon.

When the virtual item is the virtual ammunition or the virtual accessory, the terminal continues to determine whether the virtual ammunition or the virtual accessory is the virtual item that is used by a virtual weapon. When the virtual item is the virtual item that is used by the virtual weapon, operation 1005 is performed. When the virtual item is not the virtual item that is used by the virtual weapon, operation 1006 is performed.

Operation 1005: Determine that the virtual item is not the useless virtual item.

When the virtual item is not the virtual item that is used by the virtual weapon, the terminal determines that the virtual item is not the useless virtual item.

Operation 1006: Determine that the virtual item is the useless virtual item.

When the virtual item is not the virtual item that is used by the virtual weapon, the terminal determines that the virtual item is the useless virtual item.

FIG. 11 is a flowchart of quickly discarding a useless virtual item in a backpack interface according to an exemplary aspect of this application.

Operation 1101: Receive a touch-and-hold operation on a discard control.

A terminal receives the touch-and-hold operation of a user on the discard control in the backpack interface.

Operation 1102: Determine whether a virtual object owns a useless virtual item.

The terminal determines whether the virtual object owns the useless virtual item. When the virtual object does not own the useless virtual item, operation 1103 is performed. When the virtual object owns the useless virtual item, operation 1104 is performed.

Operation 1103: Display first prompt information.

The terminal displays the first prompt information, to prompt the user that no useless virtual item exists currently.

Operation 1104: Display second prompt information and a progress bar.

The terminal displays the second prompt information to prompt the user that the useless virtual item exists currently, and displays the progress bar to notify the user of operation duration of the touch-and-hold operation.

Operation 1105: Determine that the touch-and-hold operation reaches 0.4 seconds.

The terminal determines that the touch-and-hold operation satisfies a first condition and reaches 0.4 seconds.

Operation 1106: Display discard prompt information.

The terminal displays the discard prompt information, to prompt the user to end the touch-and-hold operation and discard the useless virtual item.

Operation 1107: Determine whether the touch-and-hold operation is ended.

The terminal determines whether the touch-and-hold operation is ended. When the touch-and-hold operation is ended, operation 1109 is performed. When the touch-and-hold operation is not ended, operation 1108 is performed.

Operation 1108: End.

Operation 1109: Control the virtual object to discard the useless virtual item.

The terminal controls the virtual object to discard the useless virtual item when the touch-and-hold operation is ended.

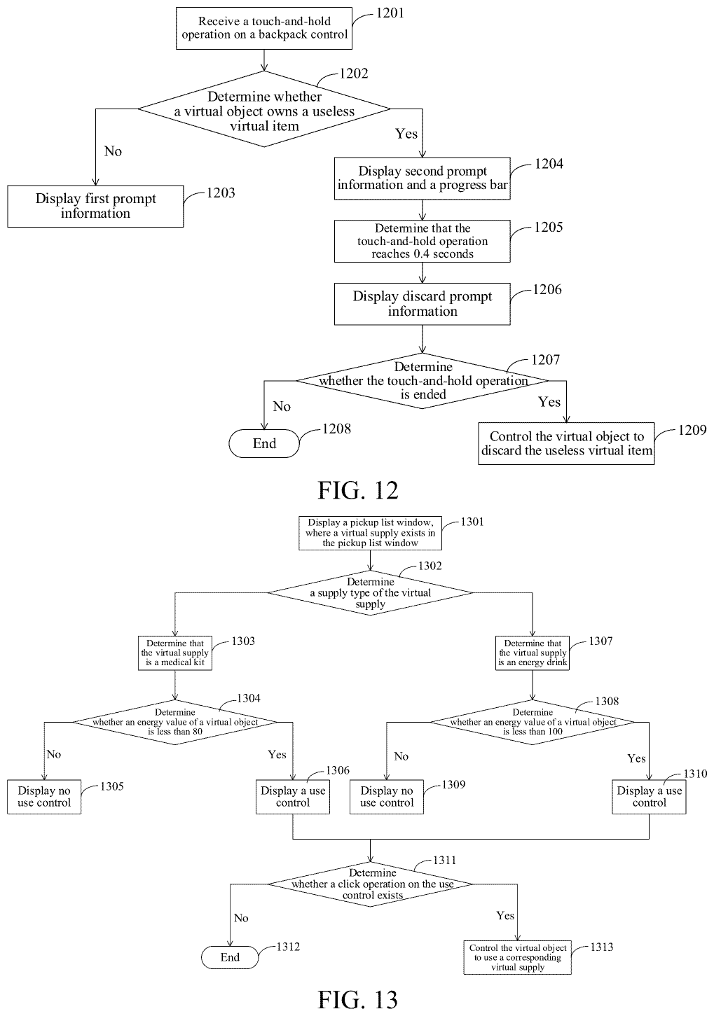

FIG. 12 is a flowchart of quickly discarding a useless virtual item in a main interface according to an exemplary aspect of this application.

Operation 1201: Receive a touch-and-hold operation on a backpack control.

A terminal receives the touch-and-hold operation of a user on the backpack control in the main interface.

Operation 1202: Determine whether a virtual object owns a useless virtual item.

The terminal determines whether the virtual object owns the useless virtual item. When the virtual object does not own the useless virtual item, operation 1203 is performed. When the virtual object owns the useless virtual item, operation 1204 is performed.

Operation 1203: Display first prompt information.

The terminal displays the first prompt information, to prompt the user that no useless virtual item exists currently.

Operation 1204: Display second prompt information and a progress bar.

The terminal displays the second prompt information to prompt the user that the useless virtual item exists currently, and displays the progress bar to notify the user of operation duration of the touch-and-hold operation.

Operation 1205: Determine that the touch-and-hold operation reaches 0.4 seconds.

The terminal determines that the touch-and-hold operation satisfies a first condition and reaches 0.4 seconds.

Operation 1206: Display discard prompt information.

The terminal displays the discard prompt information, to prompt the user to end the touch-and-hold operation and discard the useless virtual item.

Operation 1207: Determine whether the touch-and-hold operation is ended.

The terminal determines whether the touch-and-hold operation is ended. When the touch-and-hold operation is ended, operation 1209 is performed. When the touch-and-hold operation is not ended, operation 1208 is performed.

Operation 1208: End.

Operation 1209: Control the virtual object to discard the useless virtual item.

The terminal controls the virtual object to discard the useless virtual item when the touch-and-hold operation is ended.

FIG. 13 is a flowchart of quickly using a virtual supply according to an exemplary aspect of this application.

Operation 1301: Display a pickup list window, where a virtual supply exists in the pickup list window.

A terminal displays the pickup list window, where the virtual supply exists in the pickup list window.

Operation 1302: Determine a supply type of the virtual supply.

The terminal determines the supply type of the virtual supply, and a next operation is determined based on the supply type.

Operation 1303: Determine that the virtual supply is a medical kit.

Operation 1304: Determine whether an energy value of a virtual object is less than 80.

The terminal determines whether the energy value of the virtual object is less than 80. When the energy value is less than 80, operation 1306 is performed. When the energy value is greater than 80, operation 1305 is performed.

Operation 1305: Display no use control.

Operation 1306: Display a use control.

Operation 1307: Determine that the virtual supply is an energy drink.

Operation 1308: Determine whether an energy value of a virtual object is less than 100.

The terminal determines whether the energy value of the virtual object is less than 100. When the energy value is less than 100, operation 1310 is performed. When the energy value is greater than 100, operation 1309 is performed.

Operation 1309: Display no use control.

Operation 1310: Display a use control.

Operation 1311: Determine whether a click operation on the use control exists.

The terminal determines whether the click operation on the use control exists. When the click operation on the use control exists, operation 1313 is performed. When the click operation on the use control does not exist, operation 1312 is performed.

Operation 1312: End.

Operation 1313: Control the virtual object to use a corresponding virtual supply.

When the click operation on the use control exists, the terminal controls the virtual object to use the corresponding virtual supply.

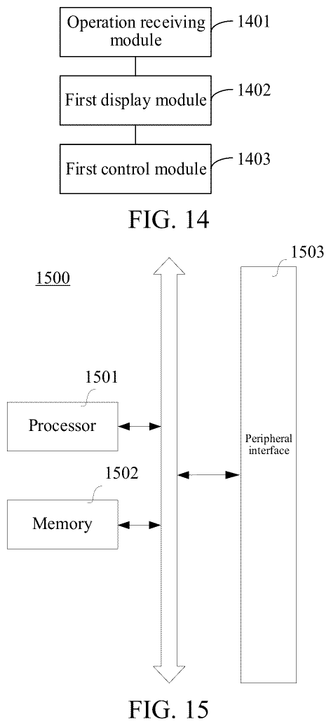

FIG. 14 is a structural block diagram of an apparatus for discarding a virtual item according to an exemplary aspect of this application. The apparatus includes: an operation receiving module 1401, configured to receive a first operation on an item management control when the virtual item is not selected, the item management control being configured to trigger management of a virtual item owned by a virtual object; a first display module 1402, configured to display discard prompt information when the virtual item owned by the virtual object includes a useless virtual item, the useless virtual item being a virtual item that is unusable by the virtual object; and a first control module 1403, configured to control the virtual object to discard the useless virtual item owned by the virtual object when the first operation is ended.

In some aspects, the item management control includes at least one of the following: a discard control in a backpack interface, a backpack control in a main interface, and a first control in a pickup list window.

The operation receiving module 1401 includes: a first receiving unit, configured to receive a first operation on the discard control in the backpack interface when the virtual item in the backpack interface is not selected; a second receiving unit, configured to receive a first operation on the backpack control in the main interface when the virtual item is not selected, where the first operation is different from a trigger operation on the backpack control when the backpack interface is viewed; or a third receiving unit, configured to receive a first operation on the first control in the pickup list window when the virtual item in the pickup list window is not selected.

In some aspects, the item management control is one of the discard control and the backpack control.

The first control module 1403 includes: a first determining unit, configured to determine, based on the useless virtual item owned by the virtual object, a discard quantity and a discard type of the useless virtual item when the first operation is ended; and a first control unit, configured to control, based on the discard quantity and the discard type, the virtual object to discard the useless virtual item owned by the virtual object.

In some aspects, the first determining unit is configured to: sort, based on an item attribute of the useless virtual item and historical item usage of the virtual object, the useless virtual item when the first operation is ended, to obtain a first sorting result, where the item attribute includes at least one of an item quantity and an item value; and determine the discard quantity and the discard type of the useless virtual item based on the first sorting result.

In some aspects, the item management control is the first control.

The first control module 1403 includes: a second determining unit, configured to determine, based on the useless virtual item owned by the virtual object and the virtual item existing in the pickup list window, a discard quantity and a discard type of the useless virtual item when the first operation is ended; and a second control unit, configured to control, based on the discard quantity and the discard type, the virtual object to discard the useless virtual item owned by the virtual object.

In some aspects, the second determining unit is configured to: sort, based on an item attribute of the useless virtual item, an item attribute of the virtual item existing in the pickup list window, and historical item usage of the virtual object, the useless virtual item when the first operation is ended, to obtain a second sorting result, where the item attribute includes at least one of an item quantity and an item value; and determine, based on the second sorting result, the discard quantity and the discard type of the useless virtual item. In some aspects, the item management control is the first control.

The apparatus further includes: a second display module, configured to display a use control in a display box corresponding to the virtual supply when a virtual supply exists in the pickup list window, where the use control is configured to implement direct use of the virtual supply; and a second control module, configured to control the virtual object to use the virtual supply in response to a second operation on the use control.

In some aspects, the second display module is configured to: determine a supply type to which the virtual supply belongs when the virtual supply exists in the pickup list window; determine, based on the supply type and an object attribute of the virtual object, a target virtual supply applicable to the virtual object; and display the use control in a display box corresponding to the target virtual supply.

In some aspects, the first display module 1402 is configured to: display the discard prompt information when an operation parameter of the first operation satisfies a first condition and the virtual item owned by the virtual object includes the useless virtual item, where the operation parameter includes at least one of operation duration and an operation force.

In some aspects, before displaying the discard prompt information, the apparatus further includes: a third display module, configured to display first prompt information when the operation parameter of the first operation satisfies a second condition and the virtual item owned by the virtual object includes no useless virtual item, where the first prompt information is configured for indicating that the virtual item includes no useless virtual item; and a fourth display module, configured to display second prompt information when the operation parameter of the first operation satisfies a second condition and the virtual item owned by the virtual object includes the useless virtual item, where the second prompt information is configured for indicating that the virtual item includes the useless virtual item.

In some aspects, before displaying the second prompt information, the apparatus further includes: a fifth display module, configured to display a progress bar on the item management control when the first operation is not ended and the first condition is not satisfied, where the progress bar is configured for indicating an operation progress of the first operation; and an adjustment module, configured to adjust an indication progress of the progress bar based on the operation progress of the first operation, where the indication progress is positively correlated with the operation progress.

In conclusion, in this aspect of this application, when a virtual item is not selected, if a terminal device receives a first operation on an item management control, the terminal device displays discard prompt information when a virtual item owned by a virtual object includes a useless virtual item. Then, the terminal device controls the virtual object to discard the useless virtual item owned by the virtual object when the first operation is ended. In this way, a user only needs to perform a one-time operation on the item management control to select and discard various useless virtual items at one time, and does not need to select and discard the useless virtual items one by one. This shortens time for discarding the useless virtual item owned by the virtual object, and further improves efficiency of discarding the useless virtual item.

The apparatus provided in the foregoing aspects is illustrated with an example of division of the foregoing functional modules. In actual application, the functions may be allocated to and completed by different functional modules according to requirements, that is, the internal structure of the apparatus is divided into different functional modules, to implement all or some of the functions described above. In addition, the apparatus and method aspects provided in the foregoing aspects belong to the same conception. For an implementation process, refer to the method aspects, and details are not described herein again.

FIG. 15 is a structural block diagram of a terminal 1500 according to an exemplary aspect of this application. The terminal 1500 may be a portable mobile terminal, for example, a smartphone, a tablet computer, a moving picture experts group audio layer III (MP3) player, and a moving picture experts group audio layer VI (MP4) player. The terminal 1500 may be further referred to as other names such as user equipment and a portable terminal.

Generally, the terminal 1500 includes a processor 1501 and a memory 1502.

The processor 1501 may include one or more processing cores, such as a 4-core processor or an 8-core processor. The processor 1501 may be implemented by using any one of the following hardware forms: a digital signal processor (DSP), a field-programmable gate array (FPGA), and a programmable logic array (PLA). The processor 1501 may also include a main processor and a coprocessor. The main processor is a processor configured to process data in an active state, also referred to as a central processing unit (CPU). In some aspects, the processor 1501 may be integrated with a graphics processing unit (GPU), which is responsible for rendering and drawing a content required to be displayed by a display screen. In some aspects, the processor 1501 may further include an artificial intelligence (AI) processor, which is configured to process a machine learning related computing operation.

The memory 1502 may include one or more computer-readable storage media. The computer-readable storage medium may be tangible and non-transitory. The memory 1502 may alternatively include a high-speed random access memory and a non-volatile memory, for example, one or more disk storage devices and flash storage devices. In some aspects, the non-transitory computer-readable storage medium in the memory 1502 is configured to store at least one instruction, and the at least one instruction being configured to be executed by the processor 1501 to implement the method for discarding a virtual item provided in aspects of this application.

In some aspects, the terminal 1500 may optionally further include: a peripheral interface 1503 and at least one peripheral device.

The peripheral interface 1503 may be configured to connect at least one peripheral device related to input/output (I/O) to the processor 1501 and the memory 1502. In some aspects, the processor 1501, the memory 1502, and the peripheral interface 1503 are integrated on a same chip or circuit board. In some other aspects, any or both of the processor 1501, the memory 1502, and the peripheral interface 1503 may be implemented on an independent chip or circuit board. This is not limited in this aspect.

A person skilled in the art may understand that the structure shown in FIG. 15 constitutes no limitation on the terminal 1500, and the terminal may include more or fewer components than those shown in the figure, or some components may be combined, or a different component deployment may be used.

An aspect of this application further provides a computer-readable storage medium, storing at least one program, the at least one program being loaded and executed by a processor to implement the method for discarding a virtual item described in the foregoing aspects.

According to an aspect of this application, a computer program product is provided, the computer program product including computer instructions, the computer instructions being stored in a computer-readable storage medium. A processor of a terminal reads the computer instructions from the computer-readable storage medium, and executes the computer instructions, to cause the terminal to implement the method for discarding a virtual item provided in the optional implementations of the foregoing aspect.

According to the aspects of this application, a prompt interface or a pop-up window may be displayed, or voice prompt information may be outputted before and during collecting user-related data of a user. The prompt interface, the pop-up window, or the voice prompt information is used for prompting the user that data related to the user is currently being collected, so that this application only starts to perform related operations of obtaining the user-related data after obtaining a confirmation operation of the user for the prompt interface or the pop-up window, otherwise (e.g., when the confirmation operation of the user for the prompt interface or the pop-up window is not obtained), ends the related operations of obtaining the user-related data, that is, skips obtaining the user-related data. In other words, all user data collected by this application is processed strictly in accordance with the requirements of relevant national laws and regulations. The informed consent or separate consent of a personal information subject is collected with the consent and authorization of the user, subsequent data use and processing activities are carried out within the scope of laws, regulations and the authorization of the personal information subject, and the collection, use and processing of user-related data need to comply with relevant laws, regulations and standards of relevant countries and regions. For example, the first operation, the second operation, the user interface, the virtual environment, the virtual object, and the like involved in this application are all obtained with full authorization.

A person skilled in the art should be aware that in the one or more examples, the functions described in the aspects of this application may be implemented by using hardware, software, firmware, or any combination thereof. When implemented by using software, the functions can be stored in a computer-readable storage medium or can be used as one or more instructions or code in a computer-readable storage medium for transmission. The computer-readable storage medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely optional aspects of this application, but are not intended to limit this application. Any modification, equivalent replacement, or improvement made within the spirit and principle of this application shall fall within the protection scope of this application.

What is claimed is:

1. A method comprising:
receiving, by a computing device, a first operation on an item management control on a user interface when a virtual item owned by a virtual object is not selected, the item management control being configured to trigger management of the virtual item;
displaying discard prompt information based on a determination that the virtual item is unusable by the virtual object; and
controlling the virtual object to discard the virtual item in response to an end of the first operation.

2. The method according to claim 1, wherein the item management control on the user interface comprises at least one of the following: a discard control in a backpack interface, a backpack control in a main interface, and a first control in a pickup list window; and
the receiving the first operation comprises at least one of the following:
receiving the first operation on the discard control in the backpack interface when the virtual item in the backpack interface is not selected;
receiving the first operation on the backpack control in the main interface when the virtual item is not selected, wherein the first operation is different from a trigger operation on the backpack control when the backpack interface is viewed; or
receiving the first operation on the first control in the pickup list window when the virtual item in the pickup list window is not selected.

3. The method according to claim 1, wherein the controlling the virtual object to discard the virtual item comprises:
determining, based on the virtual item owned by the virtual object, a discard quantity and a discard type of the virtual item in response to an end of the first operation; and
controlling, based on the discard quantity and the discard type, the virtual object to discard the virtual item.

4. The method according to claim 3, wherein the determining, based on the virtual item owned by the virtual object, the discard quantity and the discard type of the virtual item comprises:
sorting, based on an item attribute of the virtual item and historical item usage of the virtual object, the virtual item in response to an end of the first operation, to obtain a first sorting result, wherein the item attribute comprises at least one of an item quantity and an item value; and
determining the discard quantity and the discard type of the virtual item based on the first sorting result.

5. The method according to claim 2, wherein the item management control is the first control; and the controlling the virtual object to discard the virtual item comprises:
determining, based on the virtual item being in the pickup list window, a discard quantity and a discard type of the virtual item in response to an end of the first operation; and
controlling, based on the discard quantity and the discard type, the virtual object to discard the virtual item.

6. The method according to claim 5, wherein the determining, based on the virtual item being in the pickup list window, the discard quantity and the discard type of the virtual item comprises:
sorting, based on an item attribute of the virtual item, an item attribute of the virtual item in the pickup list window, and historical item usage of the virtual object, the virtual item in response to an end of the first operation, to obtain a second sorting result, wherein the item attribute comprises at least one of an item quantity and an item value; and
determining, based on the second sorting result, the discard quantity and the discard type of the virtual item.

7. The method according to claim 2, wherein the item management control is the first control, and the method further comprises:
displaying a use control in a display box corresponding to a virtual supply when the virtual supply is in the pickup list window, wherein the use control is configured to implement direct use of the virtual supply; and
controlling the virtual object to use the virtual supply in response to a second operation on the use control.

8. The method according to claim 7, wherein the displaying the use control in the display box comprises:
determining a supply type to which the virtual supply belongs when the virtual supply is in the pickup list window;
determining, based on the supply type and an object attribute of the virtual object, a target virtual supply applicable to the virtual object; and
displaying the use control in the display box corresponding to the target virtual supply.

9. The method according to claim 1, wherein the displaying the discard prompt information comprises:
displaying the discard prompt information based on a determination that an operation parameter of the first operation satisfies a first condition, wherein the operation parameter comprises at least one of an operation duration and an operation force.

10. The method according to claim 9, wherein before the displaying the discard prompt information, the method further comprises:
displaying the discard prompt information based on a determination that the operation parameter of the first operation satisfies a second condition and the virtual item owned by the virtual object is unusable by the virtual object, wherein the prompt information is configured for indicating that the virtual item is unusable by the virtual object.

11. The method according to claim 10, wherein after the displaying the discard prompt information, the method further comprises:
displaying a progress bar on the item management control before the end of the first operation and based on the first condition not being satisfied, wherein the progress bar is configured to indicate an operation progress of the first operation; and
adjusting an indication progress of the progress bar based on the operation progress of the first operation.

12. An apparatus comprising:
one or more processors; and
memory storing instructions that, when executed by the one or more processors, cause the apparatus to: receive a first operation on an item management control on a user interface when a virtual item owned by a virtual object is not selected, the item management control being configured to trigger management of the virtual item;
display discard prompt information based on a determination that the virtual item is unusable by the virtual object; and
control the virtual object to discard the virtual item in response to an end of the first operation.

13. The apparatus according to claim 12, wherein the item management control on the user interface comprises at least one of the following: a discard control in a backpack interface, a backpack control in a main interface, and a first control in a pickup list window; and
the instructions, when executed by the one or more processors, cause the apparatus to receive the first operation by at least one of the following:
receiving the first operation on the discard control in the backpack interface when the virtual item in the backpack interface is not selected;
receiving the first operation on the backpack control in the main interface when the virtual item is not selected, wherein the first operation is different from a trigger operation on the backpack control when the backpack interface is viewed; or
receiving the first operation on the first control in the pickup list window when the virtual item in the pickup list window is not selected.

14. The apparatus according to claim 12, wherein the instructions, when executed by the one or more processors, cause the apparatus to control the virtual object to discard the virtual item by:
determining, based on the virtual item owned by the virtual object, a discard quantity and a discard type of the virtual item in response to an end of the first operation; and
controlling, based on the discard quantity and the discard type, the virtual object to discard the virtual item.

15. The apparatus according to claim 14, wherein the instructions, when executed by the one or more processors, cause the apparatus to determine, based on the virtual item owned by the virtual object, the discard quantity and the discard type of the virtual item by:
sorting, based on an item attribute of the virtual item and historical item usage of the virtual object, the virtual item in response to an end of the first operation, to obtain a first sorting result, wherein the item attribute comprises at least one of an item quantity and an item value; and
determining the discard quantity and the discard type of the virtual item based on the first sorting result.

16. The apparatus according to claim 13, wherein the item management control is the first control, and wherein the instructions, when executed by the one or more processors, cause the apparatus to control the virtual object to discard the virtual item by:
determining, based on the virtual item being in the pickup list window, a discard quantity and a discard type of the virtual item in response to an end of the first operation; and
controlling, based on the discard quantity and the discard type, the virtual object to discard the virtual item.

17. The apparatus according to claim 13, wherein the item management control is the first control, and wherein the instructions, when executed by the one or more processors, cause the apparatus to:
display a use control in a display box corresponding to a virtual supply when the virtual supply is in the pickup list window, wherein the use control is configured to implement direct use of the virtual supply; and
control the virtual object to use the virtual supply in response to a second operation on the use control.

18. The apparatus according to claim 13, wherein the item management control is the first control, and wherein the instructions, when executed by the one or more processors, cause the apparatus to display the discard prompt information by:
displaying the discard prompt information based on a determination that an operation parameter of the first operation satisfies a first condition, wherein the operation parameter comprises at least one of an operation duration and an operation force.

19. The apparatus according to claim 18, wherein before displaying the discard prompt information, the instructions, when executed by the one or more processors, cause the apparatus to:
display the discard prompt information based on a determination that the operation parameter of the first operation satisfies a second condition and the virtual item owned by the virtual object is unusable by the virtual object, wherein the prompt information is configured for indicating that the virtual item is unusable by the virtual object.

20. A non-transitory computer-readable storage medium, when executed, cause:
receiving a first operation on an item management control on a user interface when a virtual item owned by a virtual object is not selected, the item management control being configured to trigger management of the virtual item;
displaying discard prompt information based on a determination that the virtual item is unusable by the virtual object; and
controlling the virtual object to discard the virtual item in response to an end of the first operation.
